(19) United States
(12) Patent Application Publication
(10) Pub. No.: US 2003/0169980 A1
(43) Pub. Date: Sep. 11, 2003

(54) Fiber optic coupling assembly and apparatus and method for making same

(75) Inventor: Hyoseok Daniel Yang, Santa Clara, CA (US)

Correspondence Address: Skjerven Morrill MacPherson LLP, Suite 700, 25 Metro Drive, San Jose, CA, 95110, US

(73) Assignee: Alvesta Corporation

(21) Appl. No.: 10/093,962

(22) Filed: Mar. 7, 2002

(51) Int. Cl. G02B 6/42

(52) U.S. Cl. 385/92

(57) ABSTRACT

An assembly for coupling light between a fiber optic cable connector and optoelectronic devices in an optoelectronic transceiver and method of fabricating the same. An Electric Discharge Machining process shapes and precisely dimensions several slots and alignment holes in a bulkhead. Several very small spherical refractive lenses are picked up and placed into each slot by a vacuum tool. Since the intake cavity at the working end of the vacuum tool has the same width and length as does each of the slots, the spherical lenses are placed in the slots precisely as picked up in the intake cavity. The spherical lenses are then secured in the slots by a coining process, which involves a force applied to a soft metal portion of the bulkhead. Under the action of the applied force, the soft metal around the spherical lenses deforms, thus embedding the spherical lenses in the slots. The bulkhead is the part of the transceiver, into one side of which the fiber optical cable plugs, while the other side is aligned to the laser diodes and the photodetectors of the transceiver.

### BACKGROUND OF THE INVENTION

1. Field of the Invention

This disclosure relates generally to fiber-optic communications system, and more specifically to optoelectronic transceivers for use with fiber-optic systems.

2. Description of Related Art

The growth of the internet has imposed a high demand on communication networks. As the demand for ever-greater bandwidth grows, a particular challenge to fiber-optic component manufacturers is to increase the bandwidth capacity of fiber-optic transmitters, receivers, and transceivers, collectively referred to as fiber-optic modules, without increasing their overall physical dimensions. The goal is to enable users of fiber-optic modules to attain higher bandwidth without increasing the sizes of their network switch boxes.

A critical move toward achieving greater bandwidth capacity while maintaining small package size lies in a simple and reliable way of coupling light between optical fibers on one end and the lasers, light-emitting diodes, or photodetectors, collectively referred to as, optoelectronic devices, on the other. Optoelectronic devices are integral part of almost every fiber-optic module. The realization of light coupling is particularly difficult in a system where optical fibers are brought into the proximity of optoelectronic devices by a fiber-optic cable connector.

Various devices for interconnecting and coupling optical fibers to optoelectronic devices are known in the art. For instance, U.S. Pat. Nos. 5,574,814, 5,671,311, and 5,781,682 disclose optical couplers. U.S. Pat. No. 5,002,357 discloses optical couplers with optical lenses.

As fiber-optic systems grow, there exists a need for simple and low-cost optical coupling devices for high-bandwidth fiber-optic transceivers that provide precise optical alignment.

### SUMMARY

Disclosed here is an optical coupling assembly for fiber-optic modules or passive fiber-optic components, and methods and apparatus of making the same. The disclosed assembly is implemented in a fiber-optic transceiver, which is a fiber-optic module that contains both a transmitter and a receiver in one housing or package.

A fiber-optic module conventionally includes optical elements to couple optoelectronic components to fibers. The module may have one or multiple channels, each coupling into a separate fiber. The optical elements may be refractive or diffractive lenses or lens arrays including graded-index elements, or light-guides that use fiber stubs. In multi-channel modules, also known as parallel-optic modules, one may either use a single lens per fiber (channel), or one arrayed optical element to couple a group of fibers to a group of optoelectronic devices. An embodiment disclosed here is employed in a fiber-optic transceiver with four transmitting and four receiving channels, thereby using a total of eight light-coupling elements. The light coupling occurs between a fiber optic cable and a laser or photodetector, and uses a set of optical elements for coupling (one optical element associated with each optical fiber in the cable). A transceiver conventionally involves a set of laser diodes and photodetectors, electronic circuitry for processing signals to/from the laser diodes/photodetectors, and a housing. The laser diodes and photodetectors are collectively referred to here as optoelectronic devices.

The transceiver includes an optical coupling assembly having a bulkhead that allows optical coupling and that has a plurality of optical elements secured therein. The optical element employed in one embodiment is a refractive ball (spherical) lens, but, as mentioned previously, other types of optical elements, such as, aspherical lenses, molded optics and diffractive optical elements may be used. The bulkhead has an outer piece and an inner piece made respectively of different metals, with two different degrees of hardness, and defines at least one bulkhead slot, either in the softer piece or between the outer piece and inner piece. The ball lenses are embedded in a line in the bulkhead slot. Upon assembly, the ball lenses create indentations at their respective positions within the bulkhead slot. The inserted ball lenses focus light from the optoelectronic devices to the fiber optic cable and vice versa. The bulkhead includes several alignment features used for assembly. These alignment features are used to align the fiber optic cable connector to one side of the bulkhead, and to align the bulkhead to the optoelectronic devices on the other side of the bulkhead.

During assembly, before the optical elements are placed into the bulkhead slots, in one embodiment an Electrical Discharge Machining (EDM) process machines the bulkhead slots to precise dimensions. Before the EDM, several such bulkheads are stacked and aligned. Then the EDM fabrication process removes the hard metal surface within the stacked and aligned bulkhead slots. As a result, soft metal surface within the bulkhead slots is exposed, and the bulkhead slot (or slots) is precisely dimensioned to accommodate the optical elements to be inserted. The advantage of this procedure is that it enables the optical elements to be placed against a smooth and soft metal surface in the bulkhead slots without being scratched or otherwise damaged during assembly. Furthermore, the EDM process machines the alignment features and the bulkhead slots at the same time, in order to precisely locate the alignment features relative to the bulkhead slots.

The optical elements are picked up and placed into the bulkhead slots by a special vacuum pickup tool that has a member including a bore. The working end of the bore contains an intake cavity. The bore is in fluid communication with a vacuum pump. The intake cavity is dimensioned to hold several of the optical elements in a linear arrangement therein. A peripheral hole on the member enables fluid communication between the bore and the ambient. To pick up the optical elements in the intake cavity, the peripheral hole is closed, creating a vacuum in the bore at the intake cavity. The optical elements have a diameter slightly smaller than the width of the intake cavity and are thereby arranged in a line within the intake cavity. After the optical elements are picked-up by the vacuum tool, the tool is brought to proximity of the bulkhead and the intake cavity is aligned with the bulkhead slot. In order to release the optical elements, the peripheral hole is opened to the ambient and the vacuum in the bore is lost, which releases the optical elements into the bulkhead slot. The optical elements may be released under the force of gravity and/or by another vacuum pulling the optical elements into the bulkhead slot. The width and length of the bulkhead slot is smaller than the intake cavity such that the several optical elements have clearance fit to the intake cavity, but have interference fit to the bulkhead slot(s). Since the bulkhead slot width is slightly smaller than the optical elements, the optical elements do not fall into the bulkhead slot when released from the pick-up tool. The purpose of the tool is to allow optical elements to be placed on top of the bulkhead slot precisely as picked up in the tool intake cavity.

One embodiment of the vacuum tool apparatus includes a video system or a microscope. The video system or microscope magnifies the image of the optical elements to an adequate size for viewing by the operator. This is used to verify that the intake cavity holds the proper number of optical elements to be placed in the bulkhead slot. The use of this tool and pickup process is not limited to lenses, but is suitable for use with any very small objects.

After the optical elements are placed on the top of the bulkhead slots, they are pressed into the slot using an assembly press. After pressing in the optical elements, they are secured in the bulkhead slot by a coining process. In one embodiment, one side of each bulkhead slot is made of a soft metal, and the opposing side is made of the harder metal. These two sides correspond to the inner and outer pieces, respectively. Alternatively, the slot may be completely defined in the softer metal. The optical elements are placed in the bulkhead slots in a linear arrangement, and a suitable force is applied to the softer metal by a die nearby to the slots. The softer metal reliably deforms around the relatively harder optical elements, thus securing the optical elements in the bulkhead slot.

The described local coining process used to secure the optical elements in the bulkhead provides several advantages in the way the optical elements are assembled into the bulkhead slot. The coining pressure is most advantageously applied very near the slots to cause local movement of the metal around the optical elements. The surface area of the metal exposed to the coining pressure is thereby kept small for better control. The coining punch (tool) is of a material harder than that of the metal subject to the coining. One advantage of the coining process is that larger tolerances are acceptable in machining the bulkhead slot, because the softer metal can be increasingly coined until the optical elements are secured to an acceptable degree of compression. Another advantage is that the optical elements are not subject to compressive forces until after they assume their proper position within the bulkhead slot. The aforementioned EDM process offers an additional advantage that reveals itself during the local coining process, as it enables the softer metal surface to reliably deform around the optical elements when the coining force is applied. Thereby the optical elements are not scratched, cracked, or otherwise damaged during assembly. Inasmuch precise alignment is critical for proper operation of fiber-optic modules, it is evident that the described invention enables an assembly process with a high degree of manufacturability.

### BRIEF DESCRIPTION OF THE FIGURES

FIG. 1 shows a perspective exploded view of a first type of optoelectronic transceiver.

FIG. 2 shows a perspective view of a second type of optoelectronic transceiver.

FIG. 3 shows a perspective view of the bulkhead used in the first and second type of transceiver shown in FIG. 1 or 2, with several ball lenses embedded therein.

FIGS. 4A, 4B show a front view and a side cross-sectional view of the bulkhead after the EDM process with several ball lenses embedded within, but before the local coining process.

FIG. 5 shows a magnified front view of a bulkhead slot after the EDM process with several lenses embedded within, but before the local coining process.

FIGS. 6A, 6B show the coining tool as applied to the bulkhead, illustrating the local coining process.

FIGS. 7A, 7B show a front view and a side cross-sectional view of the bulkhead with several ball lenses secured within, illustrating the local coining process.

FIG. 8 shows a magnified front view of the bulkhead slot with several ball lenses secured within by the local coining process.

FIGS. 9A, 9B show two other embodiments of the bulkhead.

FIG. 10 shows a perspective view of a vacuum tool that is used to pick-up and place the ball lenses in the bulkhead slot.

FIG. 11 shows a cross-sectional view of the intake cavity of the tool. Several ball lenses are illustrated in the intake cavity.

FIGS. 12A, 12B show a front view of the intake cavity of the tool. FIG. 12A illustrates the intake cavity defining a bore. FIG. 12B illustrates several ball lenses held in the intake cavity.

FIG. 13 shows the vacuum tool and the bulkhead under a video system with a microscope.

### DETAILED DESCRIPTION

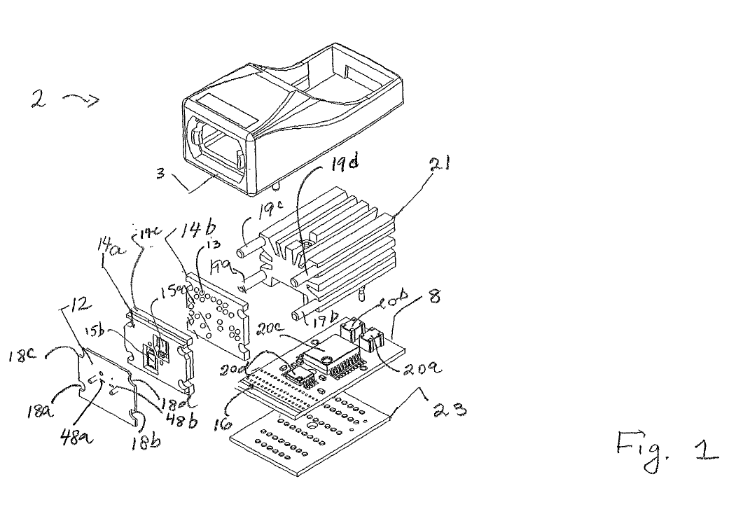

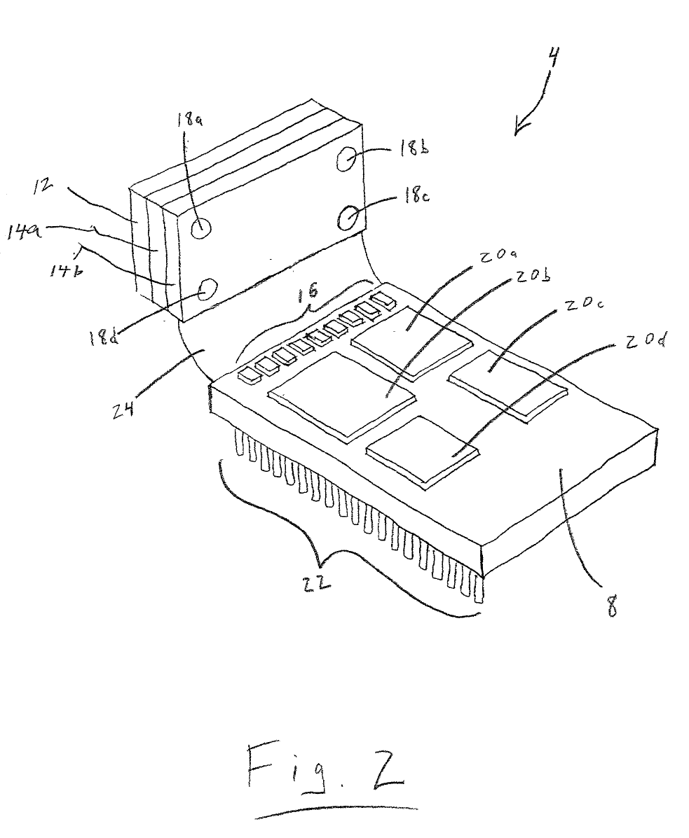

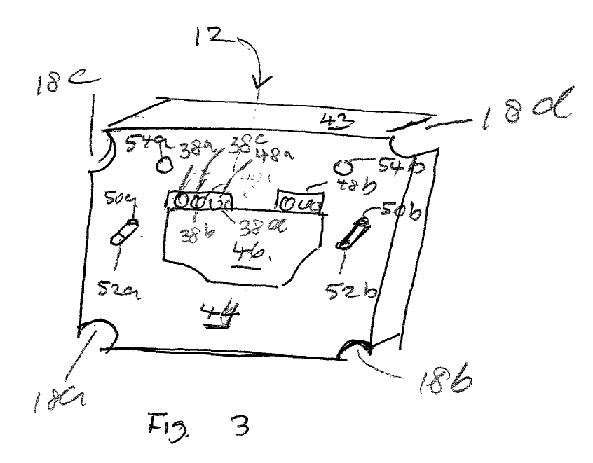

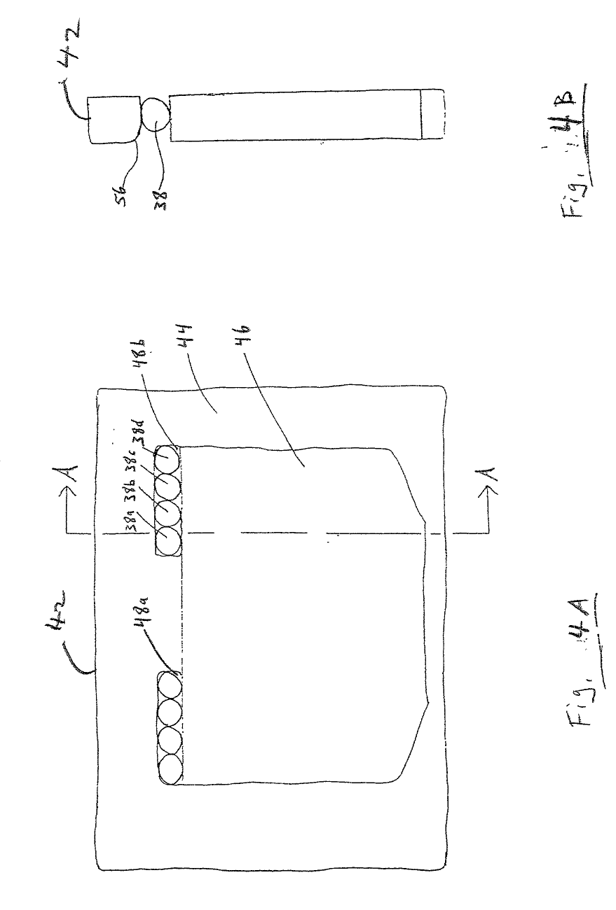

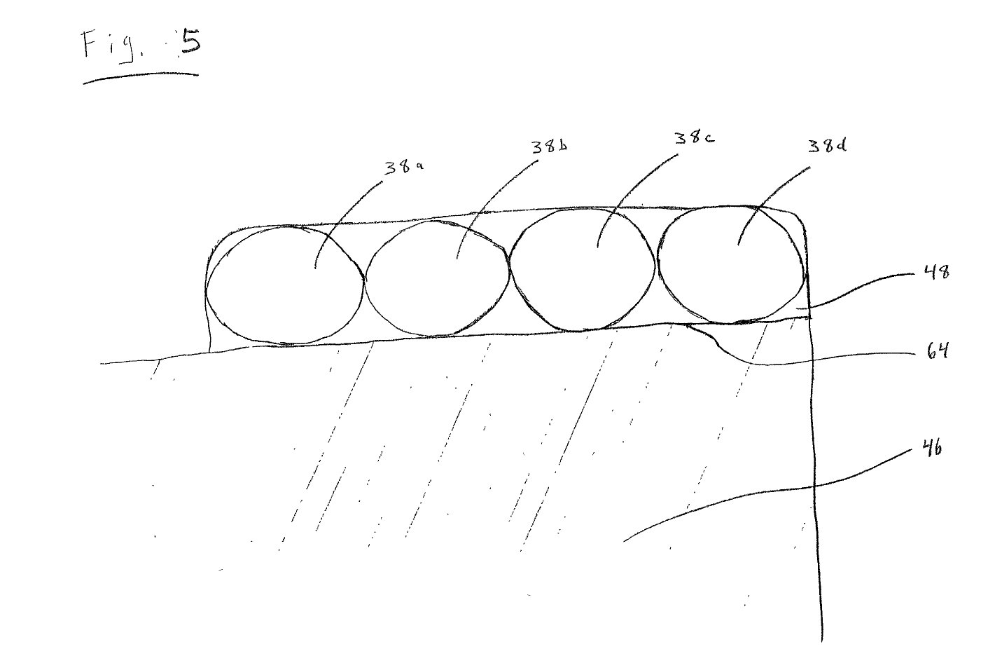

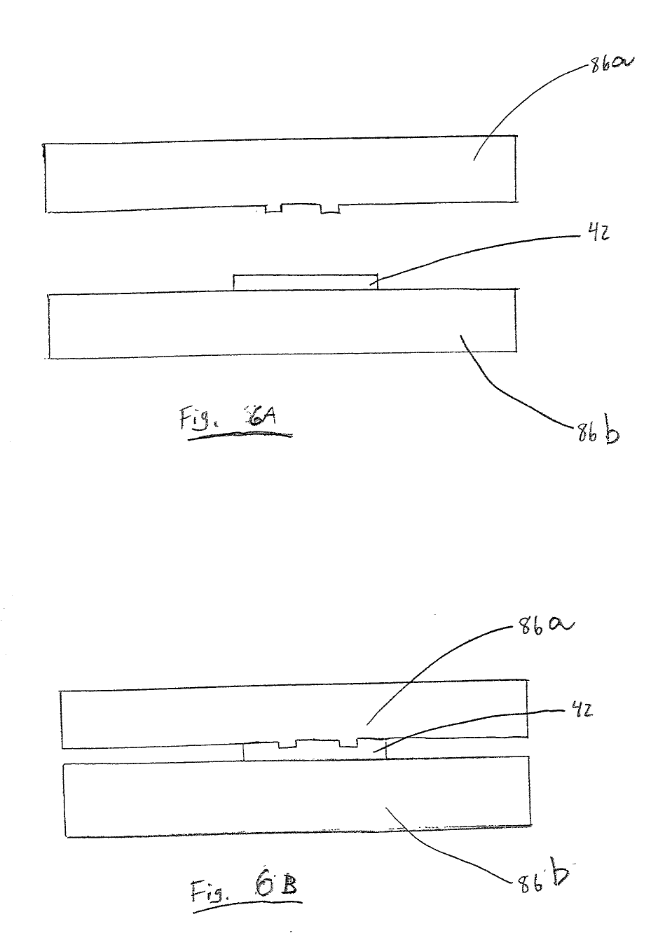

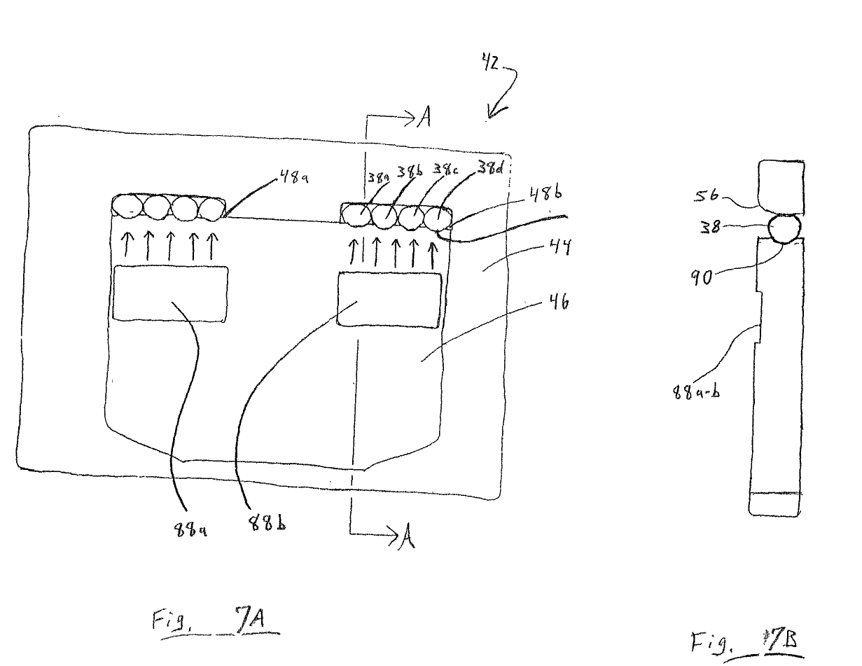

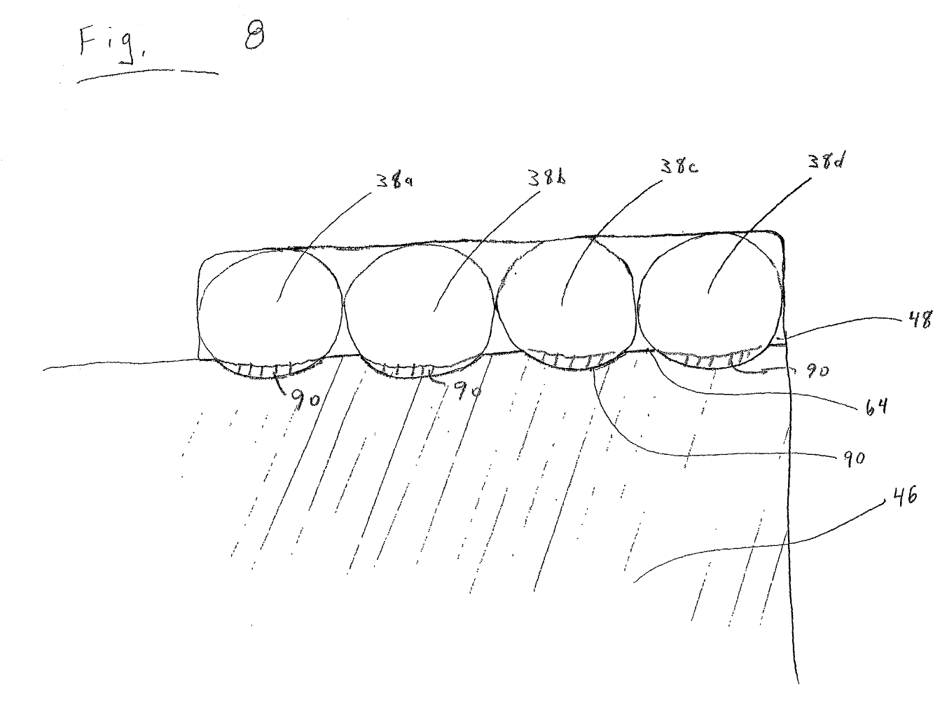

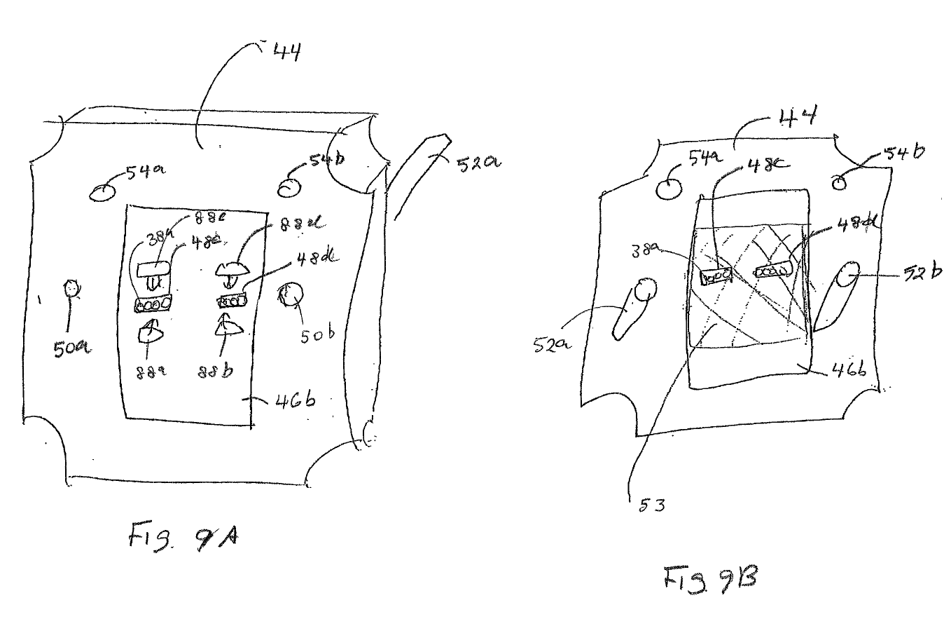

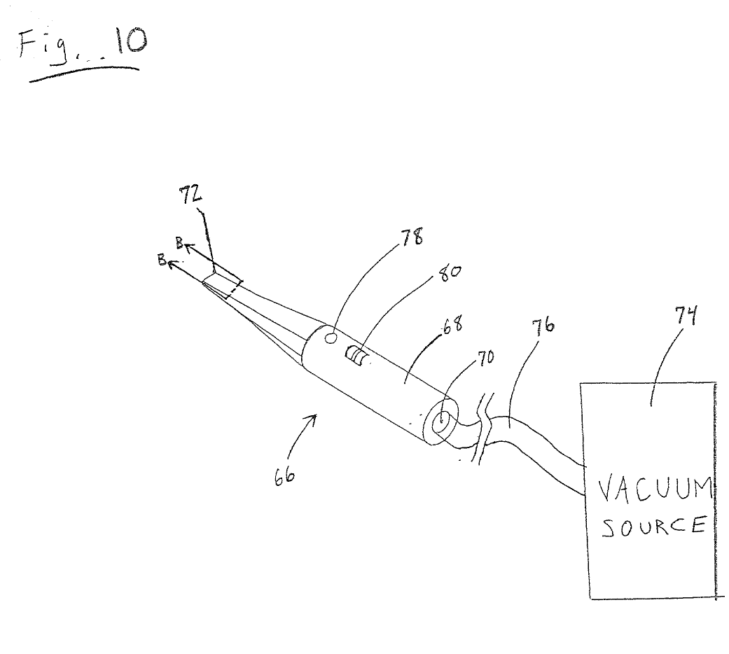

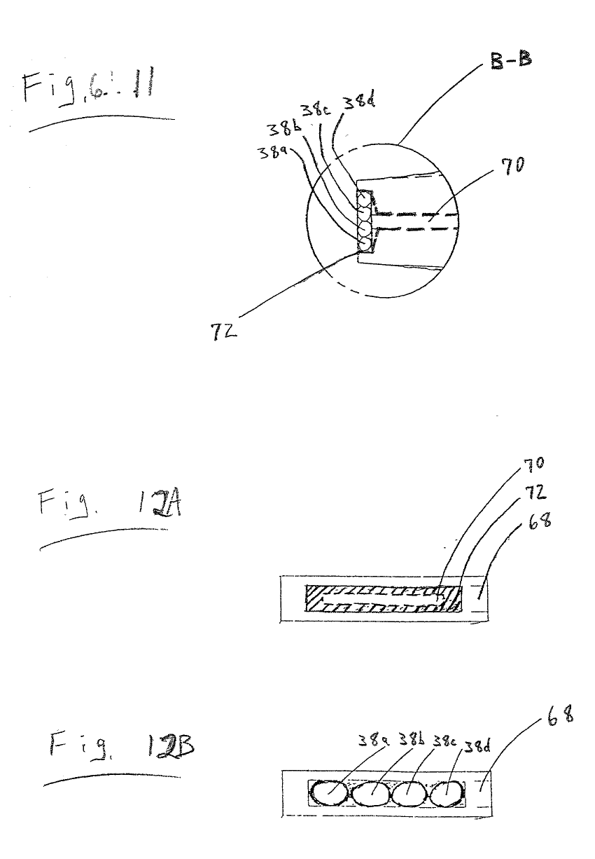

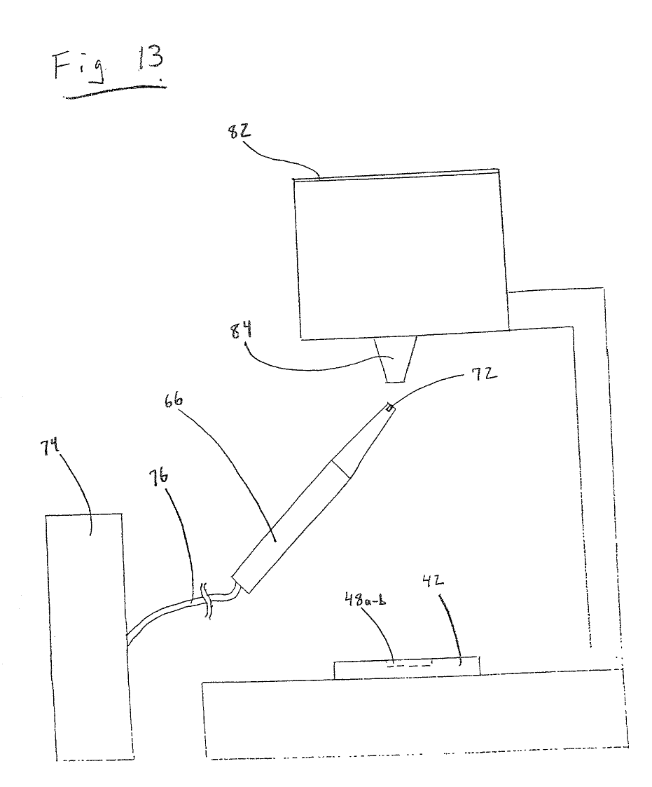

FIG. 1 shows a perspective exploded view of a transceiver 2, having several electronic components 20a, 20b, 20c, and 20d, mounted onto a transceiver circuit board 8. The housing 3 is made of plastic, but may be made of any other conductive or nonconductive material. The fiber-optic cable connector (not shown) connects to the transceiver 2 by interfacing with the optical coupling assembly 12. The fibers of the fiber-optic cable connector are precisely aligned to the optical elements inserted in the slots 48a and 48b in the optical coupling assembly 12 and the optoelectronic devices 15a and 15b mounted on the printed circuit board 14c. Attached to the printed circuit board 14c is a spacer 14a surrounding optoelectronic devices 15a and 15b. A second circuit board 14b performs signal processing, such as, filtering using passive electronic components mounted thereon and may be connected to the printed circuit board 14c via multiple contacts 13. Structures 12, 14a, 14b, 14c are mounted in a perpendicular fashion to the transceiver circuit board 8 by conventional contacts 16, on which the structures 12, 14a, 14b, 14c are solder bonded to provide a mechanical connection and a number of electrical connections. On each of the modules are defined similarly shaped and coaxially located cut outs 18a, 18b, 18c, 18d. The cut outs 18a, . . . , 18d are thereby identical in shape and position on each of the optical coupling assembly 12, the spacer 14a, and the printed circuit boards 14b and 14c. These cut outs 18a, . . . , 18d fit over corresponding rods 19a, 19b, 19c, 19d on heat sink 21. The transceiver circuit board 8 has conventional active and passive electronic components 20a, 20b, 20c, 20d mounted onto it, which are electronically connected to the contact terminals 16 to perform conventional processing of signals to/from the printed circuit boards 14c and 14b. The underside of the circuit board 8 has contacts for mounting on a system circuit board (not shown) via conventional elastomeric connector 23.

Commonly owned U.S. patent application Ser. No. 09/459,421, filed Dec. 9, 1999, entitled “Modular Fiber-Optic Transceiver,” inventor Albert T. Yuen, and Ser. No. 09/726,370, filed Nov. 29, 2000, entitled “Integrated Coupling Modules For High-Bandwidth Fiber-Optic Systems,” inventors Pierre Mertz and Dubravko Babic, are incorporated herein by reference in their entireties. In particular, Ser. No. 09/726,370 (Mertz, et al.), discloses a fiber-optic transceiver mounting a plurality of ball lenses in a bulkhead wall mated between a fiber-optic cable receptacle and optoelectronic device module. The present disclosure is directed to improvements in the bulkhead wall (part of module 12 in FIG. 1) holding the ball lenses (slots 48a and 48b in FIG. 1), which may be used in the transceivers disclosed in those applications.

FIG. 2 shows (in less detail than FIG. 1) a perspective view of relevant portions of a “flexible” transceiver 4, which is an alternative embodiment to the FIG. 1 rigid mounting of the transceiver modules onto the transceiver circuit board 8. FIG. 2 (like FIG. 1) does not show the conventional optical fiber connector, which in use is detachably plugged into the front surface of module 12. The module 12 is attached to the spacer 14a and the printed circuit board 14b. (Certain portions of transceiver 4, such as the housing 3, the heatsink 21, and the printed circuit board 14b are not shown in FIG. 2.) The structure containing the optical coupling module 12, the spacer 14a, and the printed circuit card 14b may have more modules with varying functions attached along the same assembly direction. For example, more spacers, printed circuit boards and optically functional modules may be attached. The transceiver structures 12, 14a, 14b are electrically connected to the transceiver circuit board 8 here by at least one standard flexible circuit band 24. The flexible circuit band 24 provides a high lead density to transmit the signals of the printed circuit board 14b to the transceiver circuit board 8. The flexible circuit band 24 provides mechanical flexibility between the transceiver structures 12, 14a, 14b and the transceiver circuit board 8. More than flex cable may be used for this purpose. As such, any forces applied during the connecting of the optical fiber cable will not stress or harm the connection between the transceiver structures 12, 14a, 14b and the transceiver circuit board 8. In this embodiment, an electrical contact array 22 protrudes perpendicularly out of the transceiver circuit board 8. Alternatively, the electrical contact array 22 may extend laterally from the bottom of the transceiver circuit board 8, and may also employ conventional elastomeric connector (connector 23 in FIG. 1.)

Whether the transceiver 2 or flexible transceiver 4 is used depends upon the specific system needs related to the optical transmission application. Both (and also other configurations) may incorporate the presently disclosed invention. The rigid transceiver 2 is utilized for high-density electrical contacts between the transceiver structures 12, 14b, 14c, and the transceiver circuit board 8. The flexible transceiver 4 allows for lower assembly precision and provides lower density of electrical contacts between printed circuit board 14b and the circuit board 8.

FIG. 3 shows a perspective view of the optical coupling assembly 12, consisting of a bulkhead 42, guide pins 52a and 52b, and eight ball lenses 38a, 38b, 38c, 38d, 38e, 38f, 38g, 38h. The bulkhead has an outer piece 44 and an inner piece 46. The outer piece 44 contains alignment holes 54a, 54b, guide pin holes 50a, 50b, and cutouts 18a, 18b, 18c, and 18d to accept the rods 19a, 19b, 19c, and 19d. Any of these features may also appear on the inner piece. Guide pins 52a, 52b extend from guide pin holes 50a and 50b. The outer piece 44 and the inner piece 46 define two bulkhead slots 48a, 48b each containing four of the ball lenses 38a, 38b, 38c, 38d and 38e, 38f, 38g, 38h embedded therein. The guide pins 52a, 52b are used to align the optical coupling assembly 12 with corresponding cavities in the optical fiber-optic cable connector which would thereby plug into the facing side of module 12 (not shown). Alignment holes 54a, 54b may be used to accept alignment pins extending from printed circuit boards 14b, board 14c, or heat sink 21 which thereby align structures 12, 14a, and 14b. Each ball lens 38a-30h is associated with one optical fiber and one optoelectronic transmitter (laser diode) or receiver (photodetector). In this way, four lenses are associated with four independent transmitters and another four lenses are associated with four receivers. This arrangement with eight lenses distributed in two slots is merely illustrative, and is intended to be used with four laser diodes/photodetectors on a single optoelectronic chip associated with the lenses 38a, . . . 38d in each slot 48a, 48b. Another exemplary embodiment may have only one slot with multiple lenses.

FIGS. 4A and 4B show front and side views of the bulkhead 42 with ball lenses 38a-38h inserted in respective bulkhead slots 48a, 48b in accordance with this invention.

In one embodiment, to form the bulkhead 42, a punch press separately stamps out a metal outer piece 44 and inner piece 46. The outer piece 44 is stamped such that when the inner piece 46 is press fit into the outer piece 44, two voids remain that define the bulkhead slots 48a, 48b. The exemplary bulkhead 42 thereby defines two bulkhead slots 48a, 48b, although any number of bulkhead slots 48a, 48b may be present.

In another embodiment, the sequence of fabrication is that: From a strip of metal, the inner cut out of the outer piece is stamped out and the inner piece is stamped out from a softer piece of metal. The inner (softer metal) piece is put into the cut out corresponding to each outer piece in the metal strip. The entire inner (softer metal) piece is pressed in to fit tightly into the outer piece. Then the outer edge of the outer piece is stamped out of the metal strip.

In another embodiment, the inner piece 46, rather than being stamped, may be insert molded or conventionally molded if not made of metal, for example, if the inner piece was to be made of plastic.

A rounded edge 56 is stamped at the bulkhead slots 48a, 48b to facilitate reliable placement of the ball lenses 38a, . . . , 38d into the bulkhead slots 48a, 48b. The rounded edge 56 helps insertion of the ball lenses 38a, . . . , 38d as they are later placed into the bulkhead slots 48a, 48b. Additionally, the punch press stamps out holes 50a, 50b, 54a, 54b on the outer piece 44, shown in FIG. 3.

Once the inner piece and the outer pieces are firmly engaged, an EDM process is used to precisely dimension each bulkhead slot 48a, 48b to accommodate the optical elements 38, and to create a soft surface 64 inside the bulkhead slots 48a and 48b. FIG. 5 shows an enlarged front view of a bulkhead slot 48 after the EDM process, with the ball lenses 38a, . . . , 38d embedded within the bulkhead slot 48 with soft surface 64, but before the local coining process. The bulkhead slots 48a and 48b have approximately rectangular configuration and are dimensioned so that a predetermined number of the ball lenses fit securely therein in a linear arrangement. The length of the bulkhead slot is such that the ball lenses 38a, . . . , 38d securely fit therein. The diameter of exemplary lenses is 250 μm and as such, the length of the bulkhead slot here is any multiple of 250 μm. The exemplary bulkhead slot 48 accommodates four ball lenses 38a, . . . , 38d, thus, its length is approximately 1000 μm. Since the ball lenses must securely fit within the bulkhead slot, the width and length of the bulkhead slot (prior to the local coining process) are each no more than several micrometers (e.g. 5 μm) greater than the diameter of the ball lenses linearly arranged therein. The bulkhead slot also can be slightly smaller than the diameter of the lens to provide a slight press fit to hold prior to the local coining process. The depth of the bulkhead slot (that is, the local bulkhead thickness) is typically greater than the diameter of the ball lenses. The exemplary embodiment has a bulkhead slot depth of 406 μm.

EDM is the well-known Electrical Discharge Machining, which is used to create a fine precision cut on a workpiece. An EDM machine generates a succession of localized, time-spaced and repetitive machining electrical discharges between a tool electrode and a workpiece across a machining gap. The EDM process cuts away any excess material, while improving the surface finish of the workpiece. The EDM process can be performed on multiple bulkheads 42 at once. In an exemplary EDM process, 25 bulkheads are stacked together for EDM. Before the bulkheads are stacked, however, they are subject to a conventional deburring process, whereby the surface of each bulkhead is cleaned. This process allows for better stacking and alignment. After the bulkheads are stacked and aligned, the EDM process begins to form the slots and the holes for the alignment pins in a single set up.

The protruding surface in the bulkhead slot 48 hardens over time and through punch press stamping operation. The EDM process removes this hard surface, exposing an underlying soft surface that has not yet been subject to the hardening effects of work hardening. The EDM process also eliminates the jagged composition of the hard surface, producing a smooth finish on the soft surface. An important advantage is that the EDM process enables the ball lenses 38a, . . . , 38d to be later placed against the smooth soft surface in the bulkhead slot 48 without being scratched, cracked, or otherwise damaged. This is advantageous, because precise assembly of the ball lenses within the bulkhead slots 48a and 48b is required.

As an alternative to conventional wire or sink EDM, other precision machining products can be used such as Electro Chemical Machinery (ECM) or conventional grinding or etching.

The EDM process also machines the alignment and guide pin holes 54a, 54b, 50a, 50b in the bulkhead 42 (see FIG. 3). The machining of the bulkhead slots and the alignment holes is performed in the same EDM process. As such, the bulkhead slots and the alignment feature holes are dimensioned and machined from the same frame of reference, thus improving the precision of the bulkhead slots. This is particularly advantageous, because the mating fiber-optic optic cable receptacle and the optoelectronic device modules 14a, 14b must later be precisely aligned with the ball lenses within the bulkhead slots. The alignment pins 52a, 52b are inserted into the alignment pin holes 50a, 50b by a press fit. In another embodiment, the alignment pins 52a, 52b are cold forged from the bulkhead metal itself.

The ball lenses 38a, . . . , 38d are spherical glass lenses with a typical diameter less than 500 μm. Exemplary lenses each have a diameter of 250 μm. Such ball lenses are commercially available as spherical glass bearings. An anti-reflective or attenuation coating is applied thereto. The coating may be applied either before or after the ball lenses are installed in the bulkhead. The ball lenses may be replaced with other types of optical elements having beam-focusing, beam-shaping, and other beam-coupling capabilities. Embodiments include a single optical element, or a set of optical elements. The optical elements may be made of glass, sapphire, fused silica, or any other suitable optical material that has a greater hardness than that of the softer bulkhead metal, as described below.

In this embodiment, the optical elements used to couple light from the optoelectronic devices and the optical fiber, are each a spherical (ball) glass lens. In general, the optical elements may include one or more of the following: any type of refractive lenses, diffractive lenses, single or arrayed sub-assemblies, and fiber-based light-guides. A number of these optical elements may be formed in a single member, such as a plurality of lenses formed adjacent one another in a single plastic or glass substrate. In addition to optoelectronic to fiber coupling, this bulkhead arrangement may be used for fiber to fiber coupling or free-space optics coupling.

After the ball lenses are placed in the bulkhead slots, a local coining operation is used to secure the ball lenses in the bulkhead slots. FIGS. 6A, 6B show in a side view the local coining tool 86a, 86b as applied to the bulkhead 42, illustrating the local coining process. FIGS. 7A, 7B show respectively a front view and a side cross-sectional view of the bulkhead 42, illustrating the effect of the local coining process. This coining process is performed manually or using a pneumatic press.

When placed in the bulkhead slots 48a, 48b, the ball lenses interface to both the outer piece 44 and the inner piece 46. In this way, the ball lenses touch both the hard metal and the soft metal. The coining tool 86 applies a vertical force on the inner piece 46, creating two indentations 88a, 88b on the softer metal. This force causes the softer metal to deform horizontally against the ball lenses 38a, . . . , 38d, thus embedding the ball lenses securely within the bulkhead slots 48a, 48b. In one embodiment, the softer metal inner piece 46 is made of a material having a maximum hardness of HRB 70. Examples of the softer metal include copper alloys or soft aluminum alloys. The hard outer piece 44, if of metal, is made of a material having a minimum hardness of HRC 10. Examples of the hard metal include stainless steel or nickel. It is desirable for the ball lenses to resist deformation of their spherical disposition, because such a change in shape may alter their optical characteristics. For this reason, the hardness of the ball lenses is typically substantially greater than the hardness of the softer metal.

FIG. 8 shows an enlarged front view of a bulkhead slot 48, after the local coining process. The ball lenses 38a, . . . , 38d are embedded in the bulkhead slot 48 by the softer metal side of the bulkhead slot 48. As such, the coining process creates a conforming cup indentation 90 a shown by the hatching overriding an edge of each optical element on the soft surface 64 of the soft metal at the bulkhead slot 48. The local coining of the optical elements thus produces this distinctive coined edge of the bulkhead slot where the ball lenses are embedded therein, as well as a distinctive indentation adjacent the slot in the softer metal where the coining punch was applied, as shown in FIGS. 7A, 7B.

FIG. 9A shows another bulkhead embodiment with most of the elements the same as in FIG. 3. The bulkhead slots 48c and 48d are created in the inner piece 46b and hence the ball lenses 38a, . . . , 38d are surrounded entirely by the softer material forming the inner bulkhead piece 46b. In this case, the softer material can be coined on both sides of slots 48c, 48d. Coining both sides (shown by coining marks 88a, 88b, 88c, 88d) keeps the ball lenses in the original location by applying symmetrical deformation.

The local coining process provides advantages in the way the ball lenses are assembled into the bulkhead slots. One advantage is that larger tolerances are thereby acceptable in machining the bulkhead slots, because the soft metal can be increasingly coined until the ball lenses are embedded to an acceptable degree of compression. Another advantage is that the ball lenses are not subject to compressive forces until after they assume their proper position within the bulkhead slots. The aforementioned EDM process offers an additional advantage that reveals itself during the local coining process, as it enables the soft surface to reliably deform around the ball lenses when the coining force is applied. Thereby the ball lenses are not scratched, cracked, or otherwise damaged as the optical coupling assembly 12 is constructed.

FIG. 9B shows another embodiment of the bulkhead, in most respects similar to that of FIG. 9A, in which an optically transmissive film 53 (e.g., of Kapton or thin glass) is secured over the bulkhead front surface (facing the optical cable connector which is not shown) to act as a moisture/contamination barrier. In addition, a sealant (not shown) may be provided around the optically transmissive film 53 to close any gaps between them. An optical attenuation coating may be applied on a portion of the optically transmissive film 53 to control the laser diode beam intensity.

FIG. 10 shows a perspective view of the vacuum tool 66 used in one embodiment to pick-up and place the ball lenses 38a, . . . , 38d in to the bulkhead slots 48a, 48b. The vacuum tool 66 includes a member 68 defining an interior bore 70. The bore 70 extends to an intake cavity 72 at the working end of the vacuum tool 66. At the other end of the vacuum tool 66, the bore 70 is connected by a vacuum tube 76 to a vacuum pump 74. The intake cavity 72 is in fluid communication with the vacuum pump 74, which provides for air fluid flow through the vacuum tube 76 and the bore 70. The vacuum tool 66 may alternatively have a self-contained battery and vacuum pump within the member 68, thus eliminating the physical constraints of the vacuum tube 76 and vacuum pump 74. An example of this embodiment uses the Freedom Wand™ Vacuum System, supplied by H-Square Corporation, which is powered by rechargeable batteries and a small powerful (22″-24″ of mercury) vacuum pump.

Member 68 defines two openings through which ambient air is drawn into the bore 70: the intake cavity 72 and a peripheral hole 78. When the peripheral hole 78 is closed, a vacuum is created at the intake cavity 72. Conversely, when the peripheral hole 78 is opened, the vacuum at the intake cavity 72 is lost. The peripheral hole 78 is closed and opened manually, by covering and uncovering the opening with the operator's finger. Alternatively, an electrical switch 80 controls the closing and opening of a peripheral hole 78 closure mechanism. As optical elements are picked up by the lower pressure in the intake cavity, vacuum is formed in the bore.

FIG. 11 shows a cross-sectional view B-B of the working end of the member 68 and bore 70 as illustrated in FIG. 10. The bore 70 extends to the intake cavity 72 at the working end of the member 68. The intake cavity 72 is capable of accommodating several ball lenses 38a, . . . , 38d.

FIGS. 12A, 12B show a front view of the intake cavity 72 of the vacuum tool 66. FIG. 12A illustrates the terminus of the bore 70 as it expands at the intake cavity 72. When the vacuum is created in the bore, the ball lenses 38a, . . . , 38d as are held in the intake cavity 72 as shown in FIG. 12B.

The intake cavity 72 has a rectangular configuration and is dimensioned such that a predetermined number of the ball lenses will fit securely therein in a linear arrangement. In the exemplary embodiment, the width of the intake cavity 72 is approximately 250 μm and its length is approximately 1000 μm, to hold four ball lenses 38a, . . . , 38d. Since the ball lenses must securely fit within the intake cavity 72, the width and length of the intake cavity 72 are slightly greater than the diameter of the ball lenses linearly arranged therein. The for 250 μm diameter ball lenses, the width of the intake cavity will not exceed 500 μm. The depth of the intake cavity 72 is approximately the same as the diameter of the ball lenses 38a, . . . , 38d, which is approximately 250 μm in the exemplary embodiment.

The intake cavity 72 is configured to accommodate the geometric attributes of the ball lenses 38a, . . . , 38d to be embedded in the bulkhead slots 48a, 48b. For example, the intake cavity 72 may include a spherical wall that is contoured to match the curvature of the ball lenses to be grasped. This would provide a better vacuum seal, resulting in a more secure hold of the ball lenses. The arrangement of lenses picked up by the vacuum tool 66 will depend on the application. In the exemplary embodiment, the arrangement is that of a linear row of lenses. In another embodiment, a two dimensional array of lenses may be simultaneously picked up with a tool that uses the same principle. The required pitch between the lens locations and the number of lenses will determine the size of the intake cavity. For parallel-optic modules, the pitch is preferably 250 μm in linear arrangement, but may vary depending on the application. For the case of a two-dimensional array of lenses, it may have different pitch in along the two axes of the array.

At the working end of the member 68, the bore 70 is dimensioned smaller than the diameter of the spherical elements, as illustrated in FIGS. 12A, 12B. This prevents the ball lenses 38a, . . . 38d from traveling through the bore 70 when picked up and held in the intake cavity 72. Alternatively, the intake end includes a screen or bar(s) through which air flows into the bore 70, in order to prohibit further displacement of the ball lenses therein. Any structure may be used that effectively bars the ball lenses from traveling up into the bore 70.

When the vacuum pump 74 is activated, a vacuum is created in the bore 70 at the intake cavity 72. Thus, when the working end of the member 68 is placed in close proximity to the ball lenses, the ball lenses are lifted and held in the intake cavity 72.

After lifting and holding the ball lenses 38a, . . . , 38d, the vacuum tool 66 is displaced above a bulkhead 42, and the intake cavity 72 of the member 68 is precisely aligned to the bulkhead slot 48. Once aligned, the bore is opened to the ambient, and the ball lenses are released into one of the bulkhead slots 48a, 48b. A counter vacuum is provided in one embodiment under each bulkhead slot to pull the ball lenses into the bulkhead slot from the vacuum tool.

In one embodiment, pick-up and placement of the ball lenses is performed manually by the operator of the vacuum tool 66. In this case, it is necessary for the operator to verify the proper number of ball lenses 38a, . . . , 38d contained in the intake cavity 72 and each of the bulkhead slots 48a, 48b. The pick-up process may be alternatively performed robotically. Such a robotic system would include image recognition of the intake cavity 72 and the bulkhead slots 48, in order to verify that the proper number of ball lenses is contained therein.

FIG. 13 shows an embodiment of the vacuum tool 66 and the bulkhead 42 located under observation by a video system 82. The video system 82 observes the intake cavity 72 of the vacuum tool 66 and the bulkhead slots 48a, 48b. The video system may have a microscope or the microscope may be used instead of the video. This system is used so that the operator (human or robotic) of the vacuum tool 66 can verify that the intake cavity 72 and the bulkhead slots 48a, 48b contain the proper number of ball lenses 38a, . . . 38d therein. Since the ball lenses are small, a microscope 84 may be incorporated into the video system 82 if needed for the operator to adequately view the ball lenses within the intake cavity 72 and bulkhead slots 48a, 48b. The microscope 84 would magnify the ball lenses to an adequate size for viewing.

Those skilled in the art will appreciate that the exemplary embodiments and descriptions thereof are merely illustrative of the invention as a whole. Accordingly, the present invention is not limited to the specific embodiments described herein, but rather is defined by the scope of the appended claims. Specific features of the invention may be shown in some figures and not in others, and this is for convenience only and any feature may be combined with another in accordance with the invention. While the principles of the invention have been made clear in the exemplary embodiments, it will be obvious to those skilled in the art that modifications of the structure, arrangement, proportions, elements, and materials may be utilized in the practice of the invention, and otherwise, which are particularly adapted to specific environments and operative requirements without departing from the principles of the invention. The appended claims are intended to cover and embrace any and all such modifications, with the limits only of the true purview, spirit, and scope of the invention.

What is claimed is:

1. A fiber optic assembly, comprising:
a wall comprised of a first piece surrounded by a second piece, the first and the second pieces being materials of different hardness and defining a slot at least in part in the less hard of the first and second pieces; and
a plurality of optical elements captured in the slot by a coined edge of the less hard of the first and second pieces.

2. The assembly of claim 1, wherein at least one of two pieces is of a material selected from the group consisting of plastic, ceramic, glass and metal.

3. The assembly of claim 1, wherein the harder of the two pieces is of a material selected from the group consisting of stainless steel and nickel, and the less hard of the two pieces is selected from the group consisting of copper and its alloys, and aluminum and its alloys.

4. The assembly of claim 1, wherein the hardness of the first piece is greater than the hardness of the second piece.

5. The assembly of claim 1, wherein each optical element being a sphere of less than 1000 μm in diameter.

6. The assembly of claim 1, wherein the slot is defined at least in part between the first and the second piece.

7. The assembly of claim 1, wherein the slot is defined in the less hard of the two pieces.

8. The assembly of claim 1 wherein the hardness of the second piece is greater than the hardness of the first piece.

9. The assembly of claim 1, wherein the plurality of optical elements are in a single lens array member.

10. The assembly of claim 1, wherein the hardness of the optical elements is greater than the hardness of the less hard of the two pieces.

11. The assembly of claim 1, wherein the optical elements have a maximum dimension no more than 500 μm.

12. The assembly of claim 1, wherein the optical elements have a maximum dimension no more than 250 μm.

13. The assembly of claim 1, wherein the plurality of optical elements are arranged linearly in the slot.

14. The assembly of claim 1, wherein the depth of the slot is greater than a diameter of the optical elements.

15. The assembly of claim 4, wherein the depth of the slot is greater than 250 μm.

16. The assembly of claim 1, further comprising at least one alignment cavity defined in the first piece, and at least one alignment pin extending from the first piece.

17. The assembly of claim 1, further comprising an optically transmissive film extending over the slot.

18. The assembly of claim 1, further comprising a sealant in the slot.

19. An optoelectronic transceiver comprising:
a base;
a first module mounted on the base and carrying at least one optoelectronic device;
a second module mounted on the base adjacent the first module and being adapted to connect to a fiber optic cable connector, the second module including a wall comprised of an inner piece and an outer piece, being of materials of different hardness and defining a slot at least in part in the less hard of the two pieces; and
a plurality of optical elements captured in the slot by a coined edge of the less hard of the two pieces.

20. A method of making an optical assembly, comprising the acts of:
providing a first piece defining an opening;
providing a second piece and fitting the second piece in the opening, wherein the first piece and second piece are of different hardness, and wherein a slot is defined at least in part in the less hard of the two pieces after they are fitted together; and
securing a plurality of optical elements in the slot by coining the less hard of the two pieces.

21. The method of claim 20, wherein the slot is defined between the first piece and the second piece.

22. The method of claim 20, wherein the slot is defined in the less hard of the two pieces.

23. The method of claim 20, further comprising the act of electrical discharge machining of the slot.

24. The method of claim 23, further comprising the act of electrical discharge machining additional cavities defined in the first piece.

25. The method of claim 24, wherein the slot and holes are machined in one set up.

26. The method of claim 20, wherein the optical elements are less than 1000 μm in diameter.

27. The method of claim 20, wherein the securing the plurality of optical elements includes:
providing a vacuum;
picking up the plurality of optical elements in a linear alignment; and
depositing the plurality of optical elements in the slot by reducing the vacuum.

28. An apparatus for handling a plurality of spherical elements comprising:
a member defining a bore, wherein the bore is in fluid communication with a vacuum pump;
an intake cavity of the member at the terminus of the bore, wherein the intake cavity is configured to receive the plurality of the spherical elements arranged linearly therein; and
a peripheral hole defined in the member, wherein the peripheral hole is in fluid communication with the bore and the ambient.

29. The apparatus of claim 28, wherein the diameter of the spherical elements is approximately 250 μm.

30. The apparatus of claim 28, wherein the width of the intake cavity is approximately the same as the diameter of the spherical elements.

31. The apparatus of claim 30, wherein the width of the intake cavity is approximately 250 μm.

32. The apparatus of claim 28, wherein the width of the intake cavity is about 20 μm greater than the diameter of the elements.

33. The apparatus of claim 28, wherein the length of the intake cavity is about 20 μm greater than the length of the linear arrangement of the elements.

34. The apparatus of claim 28, wherein the depth of the intake cavity is approximately the same as the diameter of the elements.

35. The apparatus of claim 34, wherein the depth of the intake cavity is approximately 250 μm.

36. The apparatus of claim 28, wherein the shape of the intake cavity is configured to receive a plurality of spherical elements arranged in a two-dimensional array.

37. The apparatus of claim 35, wherein the separation between the spherical elements arranged in the said two-dimensional array is approximately 250 μm.

38. The apparatus of claim 28, wherein the vacuum source is one of a vacuum pump located in the member or a tube coupled to a remote vacuum pump.

39. The apparatus of claim 28, further comprising a video system located to observe a workpiece into which the spherical elements are to be placed.

40. A method of handling a plurality of elements, each element being less than 1000 μm in diameter, comprising the acts of:
providing a vacuum;
picking up the elements in a linear arrangement with the vacuum;
aligning the picked up elements with a slot defined in a workpiece; and
releasing the elements into the slot by reducing the vacuum.

41. The method of claim 40, further comprising viewing the elements by video or microscope during the picking up and release of the spherical elements.

42. The method of claim 40, wherein the elements are each a ball lens no more than 500 μm in diameter.

43. The method of claim 40, further comprising the act of providing additional vacuum to pull the elements into the slot.
